(19) United States
(12) Patent Application Publication
(10) Pub. No.: US 2017/0068421 A1
(43) Pub. Date: Mar. 9, 2017

(54) DYNAMIC USER INTERFACE

(71) Applicant: Carneros Bay Capital, LLC, San Francisco, CA (US)

(72) Inventors: Mark CARLSON, Half Moon Bay, CA (US); Gary BENDER, San Rafael, CA (US); Julian HUA, Walnut Creek, CA (US)

(21) Appl. No.: 15/256,451

(22) Filed: Sep. 2, 2016

Related U.S. Application Data
(60) Provisional application No. 62/213,677, filed on Sep. 3, 2015.

(51) Int. Cl. G06F 3/0481; G06Q 40/02

(52) U.S. Cl. CPC G06F 3/04817; G06Q 40/02

(57) ABSTRACT

In one embodiment, a dynamic icon is used to indicate a value or health of the data represented in the corresponding application. An icon provides varying information in response to a user action, without opening the application. Icons are provided with contextual tips to guide the user in real time to make good financial decisions.

### CROSS-REFERENCES TO RELATED APPLICATIONS

This application claims the benefit of U.S. Provisional Patent Application No. 62/213,677 filed Sep. 3, 2015, entitled “Prepaid Card Platform”, the disclosure of which is hereby incorporated herein by reference in its entirety.

### BACKGROUND OF THE INVENTION

Various embodiments of the present disclosure generally relate to user interfaces. More specifically, various embodiments of the present disclosure relate to dynamic icons, badges and real time educational information.

Dynamic icons have been used to convey basic information to a user, without requiring the user to tap the icon or launch the application corresponding to the icon. Examples include the date on a calendar icon and the time on a clock icon. Pub. No. 20140245227 describes a compass icon with a direction needle and a weather forecast icon alternately displaying temperature and humidity. Pub. 20130337785 shows a dynamic icon which displays information from many applications, rather than being tied to one application, with the content depending on the time of day and other parameters (e.g., current weather first thing in the morning). Pub. 20130138723 shows a dynamic icon updated based on location (e.g., local weather for weather icon).

Badges are also used to provide information about an application. A typical badge is a red circle at the corner of an icon indicating a number. The number is the number of unread messages for an email icon, unread texts for a message icon, and number of available updates for an application store icon. Pub. 20150074525 describes badges that are configurable by the user.

For example, the user may select which type of item (new, most recently viewed, an item of particular type, an item associated with a particular person, etc.) they want to be notified about.

There are many applications for use on a smart phone or other device for enabling transactions, such as a digital wallet. Customers can receive alerts about transactions, and can receive financial advice. For example, a customer can be prompted to use a particular card because of the points it will generate at a particular merchant (See, e.g., Visa U.S. Pub. 20140040127). U.S. Pub. 20120232968 describes using video images analysis to recognize logos, etc. and assist the user with selecting an appropriate payment account for a transaction. U.S. Pub. 20160034932 describes providing real time financial advice in response to transactions. For example, after purchasing a coffee at a coffee store, a user may receive a notification via her mobile device that she has spent $300 that month at the same coffee store. This can be compared to a budget, and a financial wellness score can be provided. Intuit U.S. Pat. No. 8,301,501 describes showing the effect of a potential purchase on a user's budget goals and balance.

### BRIEF SUMMARY OF THE INVENTION

In one embodiment, a dynamic icon is used to indicate a value or health of the data represented in the corresponding application. For example, red, yellow and green can be used to indicate how good a credit rating is for a credit application. In another example, a scale of 1-10 can be used. Alternately, a number can be used, such as 5K indicating a balance over $5000 in a bank account.

In one embodiment, an icon provides varying information in response to a user action, without opening the application. For example, a user swiping the icon could cause it to change from showing an account balance to showing a last transaction amount. In one embodiment, a badge is used instead of changing an icon. In one embodiment, the icon is user configurable.

In one embodiment, icons are provided with contextual tips to guide the user in real time to make good financial decisions. The tip icon can be an image on a dynamic icon, a badge, or a separate icon. The icon can provide the tip directly, especially if it can be provided with few digits or letters, or an image. Alternately, the user can swipe or otherwise interact with the tip icon to obtain the guidance.

### BRIEF DESCRIPTION OF THE DRAWINGS

Embodiments of the present disclosure will be described and explained through the use of the accompanying drawings in which:

FIG. 1 illustrates an example of a network-based operating environment in accordance with various embodiments of the present disclosure.

FIG. 2 illustrates a set of components in an Application Platform in accordance with various embodiments of the present disclosure.

FIG. 3 is a set of components in an Application Platform in accordance with various embodiments of the present disclosure.

FIG. 4 is a diagram of a display showing dynamic icons and badges in accordance with various embodiments of the present disclosure.

FIG. 5 is a flowchart illustrating a process of providing account information to a cardholder in accordance with various embodiments of the present disclosure.

FIG. 6 illustrates an example of a computer system with which some embodiments of the present disclosure may be utilized.

FIG. 7 illustrates an example of a network-based operating environment in accordance with another embodiment of the present disclosure.

### DETAILED DESCRIPTION OF THE INVENTION

Dynamic icons.

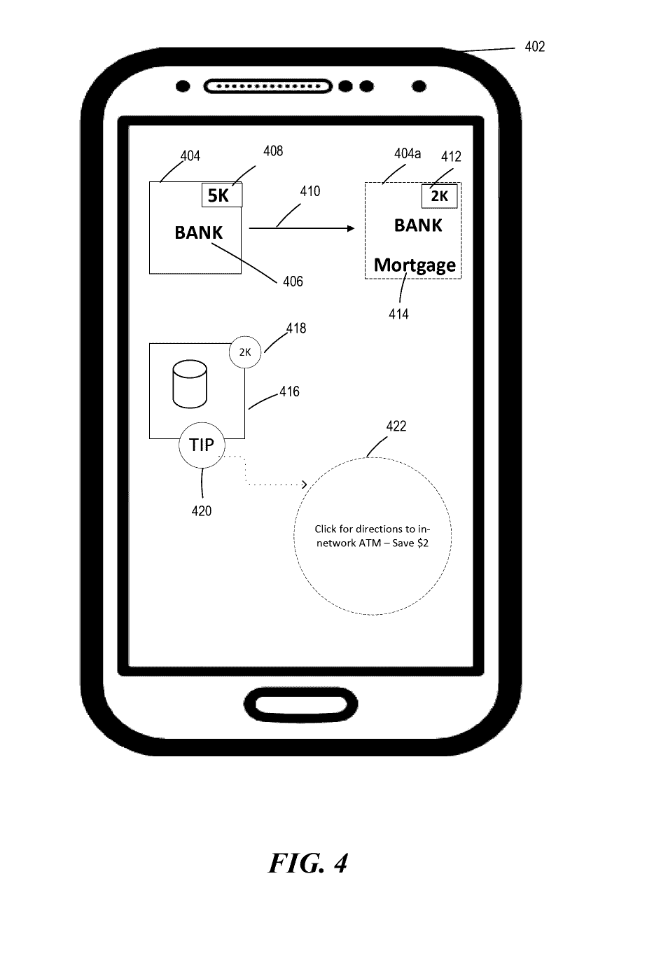

FIG. 4 is a diagram of a display showing dynamic icons and badges in accordance with various embodiments of the present disclosure. A smartphone 402 has a display with a banking icon 404. A label 406 identifies the application. Without needing to touch the icon, or open the application, certain key information can be provided to the user. In the example shown, a banking account application has a balance display 408 shown in the upper right corner of icon 404. The balance of $5000 is abbreviated to 5K. The user can swipe the icon in the direction of arrow 410 to provide an updated icon 404a (shown moved in the figure, but in a preferred embodiment, without moving the location of the icon). The update shows in icon display 412 what the balance will be after the next auto-payment due within a specified time period, such as the next 5 days. An identifier 414 indicates that the auto-payment is a mortgage auto-payment.

A dynamic status indicator module may receive information from a communications module and provide a multi-dimensional and dynamic user interface, giving users a “teller-like” experience on a computing device. As opposed to many icons which are static and in which the user must actually open the application to obtain information, the icon associated with the prepaid card is dynamic and provides constant information by displaying information without the user having to open or use the application. For example, a dynamic status indicator module may passively inform the cardholder of his or her balance by changing the color and/or symbol of their icon. If the icon turns red, yellow, a mixture of red and yellow, green, or other color the cardholder may immediately know or generally know the balance of their account. A red icon may indicate that the balance is at $0. A yellow icon may indicate that the balance is under $100. An icon that is red fading into yellow or orange may indicate that the balance is between $0-$100, and the closer the amount is to $0, the more red (and less yellow) appears. Green may indicate that the card has funds over $100. The levels at which the limits for the colors appear may be configurable by the user.

In some embodiments, the icon may scroll through a series of information such as the cardholder's last two transactions, the cardholder's balance, and a color indicator of the balance. In some embodiments, the icon could turn a certain color and display the balance numerically. If the card is closed, has been stolen, or if fraudulent activity is suspected, the icon could display a closed, thief, or warning symbol. If the user is a secondary user of the card and the primary user does not want the secondary user to use the card (e.g., at certain locations, in general) the icon may reflect a symbol indicating this message. This saves customers from potential embarrassment and it saves the card issuer fees in processing the transaction.

Dynamic badges.

FIG. 4 also shows and icon 416 with a badge 418. Such badges have been commonly used to indicate the number pending items. For example, badges have been used to show the number of new emails for an email application icon, the number of new text messages for a text message icon, and the number of updates available for an application store icon.

In one embodiment, a badge or a dynamic icon is used to indicate a value or health of the data represented in the corresponding application. For example, red, yellow and green can be used to indicate how good a credit rating is for a credit application. In another example, a scale of 1-10 can be used. Alternately, a number can be used, such as 5K indicating a balance over $5000 in a bank account. Multiple badges can be used, such as in different corners of an icon, to represent different information.

In one embodiment, a badge can be used to indicate status of an application. For example, a user may have an application for a Starbucks® card. The badge can display a number which decrements from 10 until the user qualifies for a free drink. In another example, a badge can display the quality of a credit score for a credit application. The badge can be different colors, or a number, or both.

In some embodiments, a user can configure the type of information. For example, a badge or dynamic icon may display just the number of unread VIP emails, instead of all emails, or messages from a particular person. The names of the VIPs could be scrolled through on a second dynamic image on the icon.

In one embodiment, an application provides dynamic icon and badge display data to an operating system, and the operating system causes the display of the icon and badge to be modified accordingly. The operating system may only see an image for display, with the application providing the image with a badge or dynamic image. The icon image data can be changed at the allowable refresh rate of the operating system. In another embodiment, the raw data is provided by the application to the operating system, and the operating system generates appropriate icon and badge images. In a third embodiment, an icon module is provided to receive icon data from multiple applications, and provide consistent instructions for display to an operating system.

Contextual tips icon.

In some embodiments, after an application platform detects certain user activity that warrants a tip (i.e., quick financial literacy reminders), the icon could change (or scroll through) to display a “T” or “TIP” or other symbol (420 in FIG. 4) indicating that a tip pertinent to the user/transaction is available if the user opens an application, checks text or email messages, or views a push notification. For example, if the user does a withdrawal at an out-of-network ATM, the icon may display a “T” indicating that a tip is available regarding the transaction. The tip may alert the user that the user could have saved $2 on ATM fees at an in-network ATM.

In some embodiments, an application or platform determines when a user might perform a certain action (i.e. when a user is likely to initiate a transaction) by analyzing user transaction history to determine user patterns, propensity, frequency, preference, tendency, behavior and/or trends, then dynamically changing an icon indicating a financial tip is available and/or pushing a text, email and/or push notification. For example, the user transaction history shows that the user exhibits a frequency-based pattern when withdrawing cash from an ATM (e.g. every Friday on a bi-weekly basis the user withdraws cash between 5:00 pm to 8:00 pm). Based on the pattern, the icon may dynamically indicate that a tip is available before the user performs the action. The tip may alert the user that the user can save on ATM fees by withdrawing cash at an in-network ATM and provide a map and/or listing with the closest in-networks ATMs near the user's location prior to when the user might perform the action.

FIG. 4 shows a TIP icon 420 which is associated with icon 416, similar to a badge. Alternately, the TIP icon can be part of icon 416, or separated from but associated with icon 420. Upon a user action, such as a tap or swipe, TIP icon 420 can expand, and optionally move, to be a larger icon 422 with the tip information. In the example shown, the tip says “Click for directions to in-network ATM—Save $2.” Upon the user clicking, a map application can be opened with an indicator of the closest in-network ATM and directions on how to get there from the user's current location.

In one embodiment, an application can detect that a user is calling a customer service number that charges by the minute, and can display a tip with the URL of a help site corresponding to the business being called. The number detected can be matched to a business in a table, and the corresponding URL can be retrieved. Alternately, a search could be done over the Internet to locate the associated business or URL. The application can obtain the number dialed information from the operating system with an appropriate request on some manufacturer devices. The application can interact with other apps on Android™ devices using Intents (passing data from one application to another) and through Services (where one application provides functionality for others to use).

In one embodiment, an application can infer the presence of a transaction without interaction with another application that is handling the transaction. For example, artificial intelligence can be used to detect that the user device is at a particular merchant, and detect that the NFC element in the user device is active, indicating that a payment application with that merchant is occurring.

In some embodiments, the icon can change with various offers. For example, a location determination module can determine that the cardholder is near a merchant (e.g., within a threshold distance) who provides discounts for using a prepaid or other card, the icon may change to alert the user of the potential savings. In some embodiments, the icon may be used as a “hot/cold” indicator for deals, pointing the user in a direction of a merchant who offers deals for using the card. The icon can combine a hot/cold color indicator with a compass arrow indicating the direction of the merchant from the cardholder's current location, and/or a map with directions could be provided, such as by clicking on or swiping the offer icon. Some offers can be independent of a merchant, such as a discount offer for paying a phone bill with a particular card or account.

In some embodiments, location and other information is obtained from sensors or other applications on a device. Proximity to an ATM, merchant, etc. can be determined using this information, and used to infer the type of transaction about to occur. Alternately, transaction data can be provided by the application doing the transaction.

Various embodiments of the present disclosure generally relate to payment instruments. More specifically, various embodiments of the present disclosure relate to a platform for a prepaid card or other financial account. Although many examples describe a prepaid card, other cards are contemplated by this disclosure (e.g., credit cards, debit cards) as well as other financial accounts and applications (e.g., mortgage, car loan, credit rating, dedicated merchant card account).

By dynamically updating icons representing applications with account statuses and other information (e.g., real-time, as changes are made), users are provided constant information without having to open or be using the application. For example, the user may be informed of his/her balance (or a third party's account balance) by changing the color and/or symbol of the icon. In some embodiments, the icon may scroll through a series of information such as the user's last two transactions made with a prepaid card, the cardholder's balance, and a color indicator of the balance. Thus, a user may simply look down at a smartwatch, smartphone or other device and be instantaneously informed.

The platform also provides real-time, dynamic financial services information in digestible amounts that assists users with making sound financial decisions. In contrast to current methods of providing financial information to users (i.e., providing financial literacy information in a book, paragraph, or article), which generally does not increase financial literacy. The platform assists users in making good financial decisions by providing real-time tips (e.g., when the user has a card declined, a tip to check the balance before calling a representative). Additionally, tips may be provided on the cardholder's statements, pinpointing transactions in which the user could have saved money or taken a different action, or providing general advice after assessing the overall statement or series of statements. The tips may focus on steering the customer toward a certain behavior rather than just alerting the customer. The application can have velocity limits to control the number of times a customer gets the same tip. If the customer has ignored the last dozen tips on better ATM locations, for example, the application can cease providing such tips, or provide them less frequently. Also, the user can provide a designated input, such as a double tap on the TIP icon, to indicate lack of interest in such TIP and prevent its recurrence.

Additional efficiencies may be obtained by improving call procedures. For example, when a user calls for assistance, the user's call may be directed to the application. Using either typical interactive voice response techniques or advanced online intelligence, the customer's question can be answered via the application or the application can gather enough information before making a phone call to a customer care agent. The information can be delivered to the customer care agent to provide the agent with additional context for the call.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Network-based operating environment.

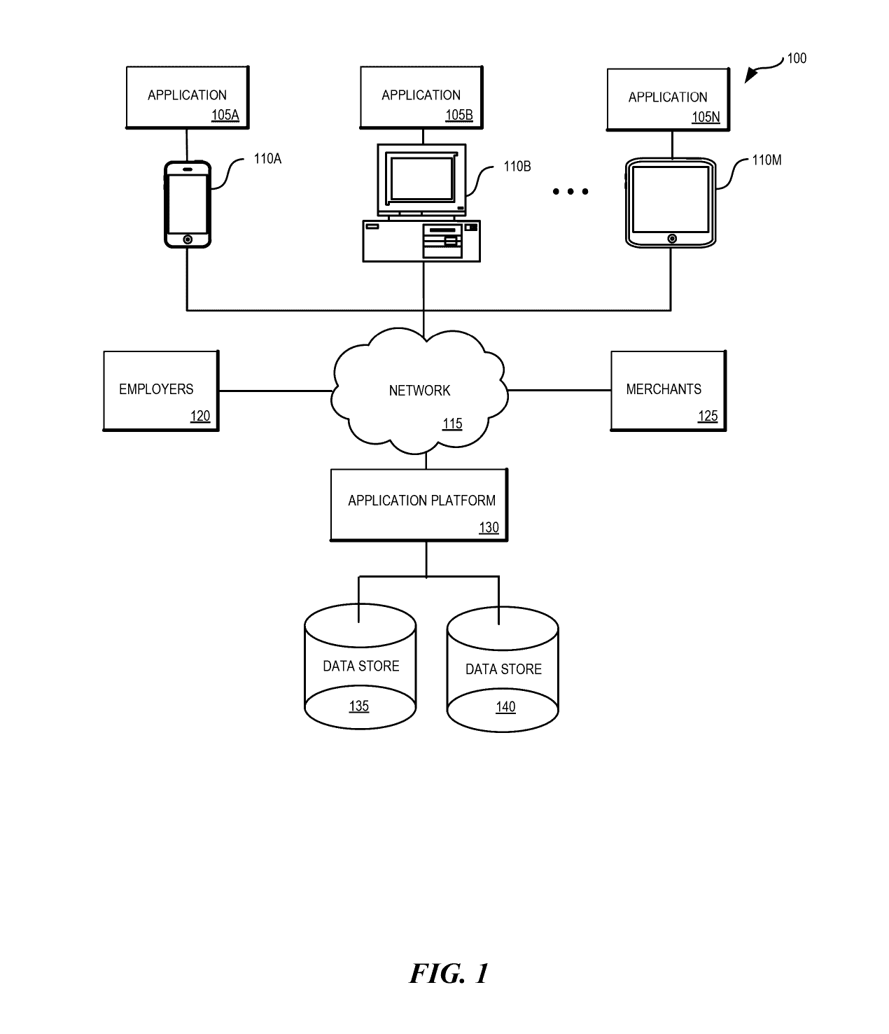

FIG. 1 illustrates an example of a network-based operating environment 100 in which some embodiments of the present disclosure may be used. As illustrated in FIG. 1, operating environment 100 includes applications 105A-105N running on one or more computing devices 110A-110M (such as a mobile device, a mobile phone, a tablet computer, a mobile media device, a mobile gaming device, a vehicle-based computer, a dedicated terminal, a public terminal, desktop, or laptop computer, a kiosk, etc.). In some embodiments, applications 105A-105N for carrying out operations such as checking and displaying account balances may be stored on the computing devices or may be stored remotely. These computing devices can include mechanisms for receiving and sending traffic by connecting through network 115 to Application Platform 130, employers 120, and merchants 125. Application Platform 130 can be an account platform (prepaid, credit, debit, loan, insurance, mortgage, etc.) or another application.

Computing devices 110A-110M are configured to communicate with Application Platform 130 via network 115. In some embodiments, computing devices 110A-110M can retrieve or submit information to Application Platform 130 and run one or more applications with customized content retrieved by Application Platform 130. For example, computing devices 110A-110M each can execute a browser application or a customized client to enable interaction between the computing devices 110A-110M, Application Platform 130, employers 120, and merchants 125.

Employers 120 are entities (i.e., natural persons, companies, or other organizations) that employ people (i.e., employees). Employers 120 can consist of any number of employees and generate any amount of revenue. Application Platform 130 may partner with employers 120 to result in the employers 120 offering employees the application (e.g., account card).

Merchants 125 may be any type of entity capable of providing purchases and/or services to consumers. Merchants 125 may reside in physical locations, such as a department store or a car dealership, or merchants 125 may reside in virtual locations such as a uniform resource locator (URL) to a merchant website or an online shopping center.

Application Platform 130 can run on one or more servers and can be used to provide a payment service (e.g., a prepaid card), provide incentives for cardholders to use the card, store and analyze pre-purchase and post-purchase cardholder data, provide incentives for employers and merchants to encourage employees and patrons to obtain and use a prepaid card, or provide real-time tips.

Network 115 can be any combination of local area and/or wide area networks, using wired and/or wireless communication systems. Network 115 could be or could use any or more protocols/technologies: Ethernet, IEEE 802.11 or Wi-Fi, worldwide interoperability for microwave access (WiMAX), cellular telecommunication (e.g., 3G, 4G, 5G), CDMA, cable, digital subscriber line (DSL), etc. Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 may be represented using technologies, languages and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

Data stores 135 and 140 can be used to manage storage of and access to user data such as account information, transaction data, registered user devices, employer data, addresses, family members, user identifications, voice profiles, authentication history, user preferences, device fingerprints, and personal identification numbers. Data stores 135 and 140 may be a data repository of a set of integrated objects that are modeled using classes defined in database schemas. Data stores 135 and 140 may further include flat files that can store data. Application Platform 130 and/or other servers may collect and/or access data from data stores 135 and 140.

Computing device.

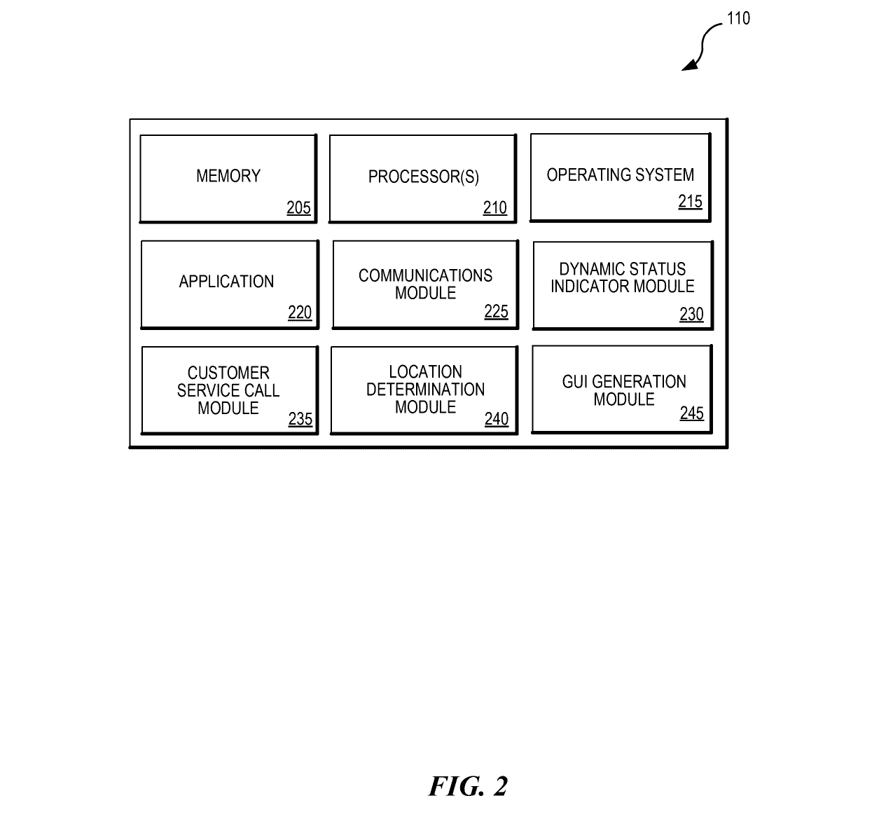

FIG. 2 illustrates a set of components within computing device 110 according to one or more embodiments of the present invention. According to the embodiments shown in FIG. 2, computing device 110 can include memory 205, one or more processor(s) 210, operating system 215, application 220, communications module 225, dynamic status indicator module 230, customer service call module 235, location determination module 240, and graphical user interface (GUI) generation module 245. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, application 220 and customer service call module 235 can be combined into a single component.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of operating system 215, application 220, communications module 225, dynamic status indicator module 230, customer service call module 235, location determination module 240, and GUI generation module 245.

Operating system 215 can provide a software package that is capable of managing the hardware resources of computing device 110. Operating system 215 can also provide common services for software applications running on processor(s) 210. In accordance with various embodiments, operating system 215 can coordinate resources for multiple applications 220 that allow a user to access and interact with Application Platform 130. For example, applications 220 can include a money transfer application, a social networking application, a banking application, and a gaming application.

Communications module 225 can send, receive, and/or access a server associated with the Application Platform 130 to retrieve account details, such as a balance or status of the account, purchases recently made, potential fraudulent activity, offers, tips, and account statements. Such information may be provided to or retrieved by communications module 225 periodically (e.g., hourly, daily, monthly, day of the month) or when an event occurs (e.g., a purchase or a reload). Communications module 225 can further send and receive authentication information.

Dynamic status indicator module 230 may receive information from communications module 225 and provide a multi-dimensional and dynamic user interface, giving users a “teller-like” experience on a computing device. The dynamic status indicator controls the icon display, and the display of a badge on the icon.

In some embodiments, after Application Platform 130 detects certain card activity that warrants a tip (i.e., quick financial literacy reminders), the icon could change (or scroll through) to display a “T” or other symbol indicating that a financial tip pertinent to the user/transaction is available if the user opens an application, checks text or email messages, or views a push notification. In some embodiments, Application Platform 130 determines when a user might perform a certain action (i.e. when a user is likely to initiate a transaction) by analyzing user transaction history to determine user patterns, propensity, frequency, preference, tendency, behavior and/or trends, then dynamically changing an icon indicating a financial tip is available and/or pushing a text, email and/or push notification.

In some embodiments, the icon can change with various offers. For example, if location determination module 240 determines that the cardholder is near a merchant (e.g., within a threshold distance) who provides discounts for using the prepaid card, the icon may change to alert the user of the potential savings. In some embodiments, the icon may be used as a “hot/cold” indicator for deals, pointing the user in a direction of a merchant who offers deals for using the prepaid card.

Customer service call module 235 provides customer service when the cardholder selects an option to call customer service or otherwise indicates that the customer needs help. The customer service call module 235 may launch the device 110's telephone application to call the selected number, but instead of dialing a customer service agent, it calls an application associated with the prepaid card (e.g., one of the applications 220) and an automated system greets the user and asks how it can help the user. Using the typical mode of speech recognition in interactive voice response systems, the application may help the user and resolve the issue or gain enough information to pass on to a representative should the user be transferred or connected to a customer service representative (e.g., via a phone call, chat, text). Thus, customer service call module 235 first secures assistance on the device and then, if the issue is not resolved and further help is needed, makes a call to a representative. When a representative is contacted, the information gained from the application (e.g., conversation with the automated system, in-app browsing information, browsing pages out of the application) can be sent to a customer service representative. Calling the application instead of an interactive voice response system provides equitable service but reduces costs to the card provider, and ultimately the customer.

Location determination module 240 detects or determines the location of computing device 110. Location determination module 240 may determine the location of computing device 110 using GPS coordinates, cell phone triangulation, a proximity detecting apparatus, or Wi-Fi input. Location determination module 240 may provide location information to dynamic status indicator module 230 or to a server associated with Application Platform 130.

GUI generation module 245 can generate one or more GUI screens that allow for interaction with a user of the computing device 110. In at least one embodiment, GUI generation module 245 generates a graphical user interface allowing a user of the mobile device to review account balances, reload a prepaid card, pay a bill, set preferences, prioritize applications, select application functionality, set device constraints, customize messages, and/or otherwise receive or convey information.

Application platform.

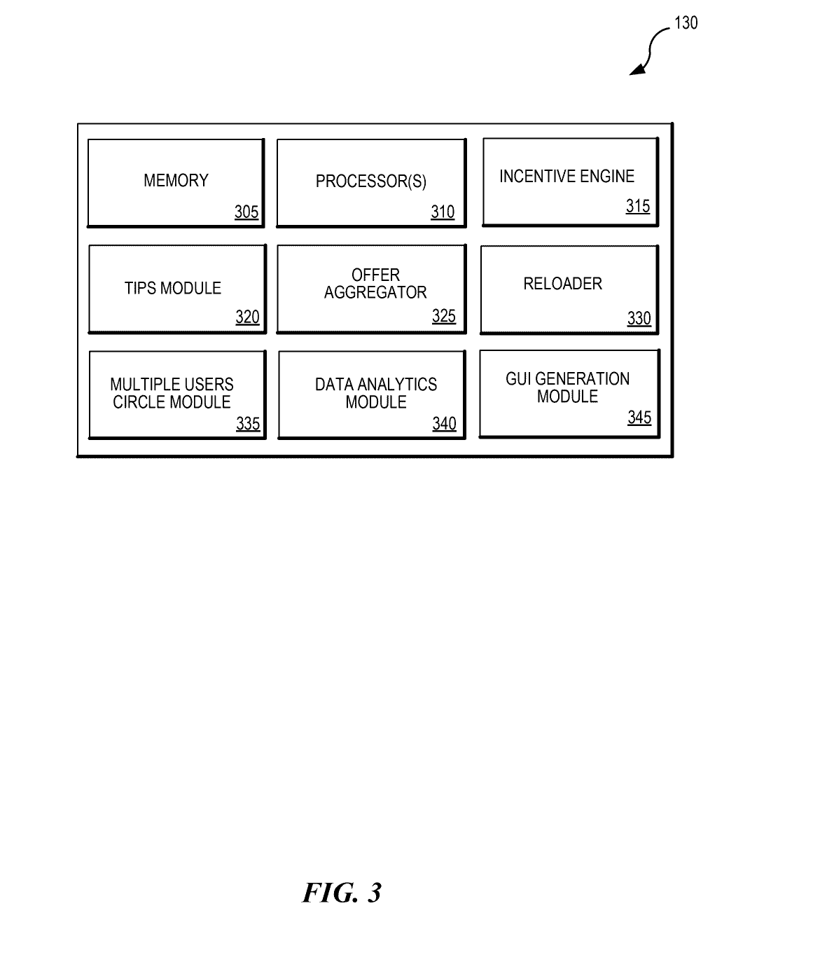

FIG. 3 illustrates a set of components within Application Platform 130 according to one or more embodiments of the present disclosure. According to the embodiments shown in FIG. 3, Application Platform 130 can include memory 305, one or more processor(s) 310, incentive engine 315, tips module 320, offer aggregator 325, reloader 330, multiple users circle module 335, data analytics module 340, and graphical user interface (GUI) generation module 345. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, tips module 320 and offer aggregator 325 can be combined into a single module for providing tips and offers to cardholders.

Memory 305 can be any device, mechanism, or populated data structure used for storing information as described above for memory 205. Memory 305 may be used to store instructions for running one or more applications or modules on processor(s) 310. For example, memory 305 could be used in one or more embodiments to house all or some of the instructions needed to execute the functionality of incentive engine 315, tips module 320, offer aggregator 325, reloader 330, multiple users circle module 335, data analytics module 340, and GUI generation module 345.

Incentive engine 315 determines and provides incentives for cardholders to continue to use the card, employers to offer the cards to employees (and encourage use), and merchants to encourage customers to obtain and use the card to make purchases in their stores.

Real time actionable tips.

Tips module 320 provides financial tips to users in the form of “Real Time Tips” or “Statement Tips.” The purposes of Real Time Tips and Statement Tips are to increase financial literacy and modify the user's behavior by providing real-time education. Statement Tips and Real Time Tips may be in any language appropriate for the user.

Real Time Tips focus on steering the customer toward a certain behavior rather than just alerting the customer and may be provided via a push notification, text message, or email to the customer's device (e.g., mobile device) within a certain period of time of a transaction. Real Time Tips may be provided in response to an event (e.g., if the user withdraws cash from an out-of-network ATM, a real-time notification could send a reminder to the user stating the user could have saved $2 by using an in-network ATM). Application Platform 130 may send the Real Time Tip as soon as possible after the triggering event occurred. In some embodiments, the user may be provided a tip prior to or during a transaction (e.g., “Ask for a price match!”). In some embodiments, pictures may be provided to make a lasting impression (e.g., a picture of an in-network ATM for additional reinforcement). In some embodiments, Real Time Tips may be provided periodically.

Statement Tips are tips provided on billing statements to remind the user how the user can save money in the future. Statement Tips may be in the form of a thought bubble or other indicator embedded in or between the lines of the statement or off to the side where money could have been saved. For example, if the user had to pay $2 because the card was declined (i.e., lack of funds), next to or within a proximity of that line item, an indicator may say “Did you know that this decline cost you $2? Please check your balance before making charges!” Thus, as the user reviews their bill, deciphering to where all the money has vanished, the user is reminded in that moment of how the user can save money and/or avoid unnecessary fees.

Offer aggregator 325 combines offers based on purchase card information known to the payment platform. In some embodiments, the card issuer has relationships with merchant partners who provide cardholders rewards for using the card. After purchase data is collected from the cardholders, additional incentives for using the card can be provided to the user. The additional incentives may be based on the purchasing habits of the user. Location information may be received from location determination module 240 and offers may be provided based on a location of the user.

Reloader 330 allows the user to reload the prepaid card with funds. The card may be reloaded with funds from a gift card, credit card, cashier's check, check or cash provided at any check or cash processing location (e.g., ATM, bank, point-of-sale, kiosk), direct deposit from an employer, or bank account (e.g., saving, checking, investment). Reloader 330 may also reload the card with funds from third parties (e.g., received via multiple users circle module 335).

Multiple users circle module 335 monitors cards that belong to a group with information sharing privileges between the group members. The card may be used by multiple people in the group or there may be separate cards. Each group member may have different access to the information for each card. Multiple users circle module 335 further provides updates or statuses regarding a fellow group member's card to one or more of the other members of the group. For example, if a college student has a prepaid card and the balance of the student's card is lower than a certain amount, a second group member (e.g., a parent) may be alerted (e.g., via icon updates, push notifications, emails, alerts in the application) and may push funds from the second group member's prepaid card or other account to the student's prepaid card (e.g., using reloader 330). In some embodiments, one member may be able to set controls on how all funds or a portion of funds (e.g., funds that the member has transferred to the other member) are used (e.g., category of store, type of item or service).

Data analytics module 340 analyzes cardholder transaction data. The data may include timing of when the cardholder is paid; the cardholder's and the employer's address, which can be used to compute that the cardholder lives or works within “n” miles of a participating merchant; timing of when cardholders spend their pay (i.e., shortly after the pay is applied to the prepaid card); an estimate of how much discretionary funds a cardholder has each month; transaction count and amount; spend by merchant categories and location; and, if available, purchase details (e.g. SKU level details of purchased items) provided by merchants.

The transaction data may be used in many ways. For example, merchants may wish to incentivize cardholders to spend discretionary funds at their location. Knowing when the cardholder will get paid and how quickly the cardholder tends to spend their money may provide valuable marketing information for the merchant. The data may further be used to determine how the merchant is performing compared to their competitors.

GUI generation module 345 can generate one or more GUI screens that allow for interaction with a user of a computing device. In at least one embodiment, GUI generation module 345 generates a graphical user interface allowing a user to view customer or employee participation, view cardholder transaction data, set alerts, customize messages, and/or otherwise receive or convey information to the user.

Process flowchart.

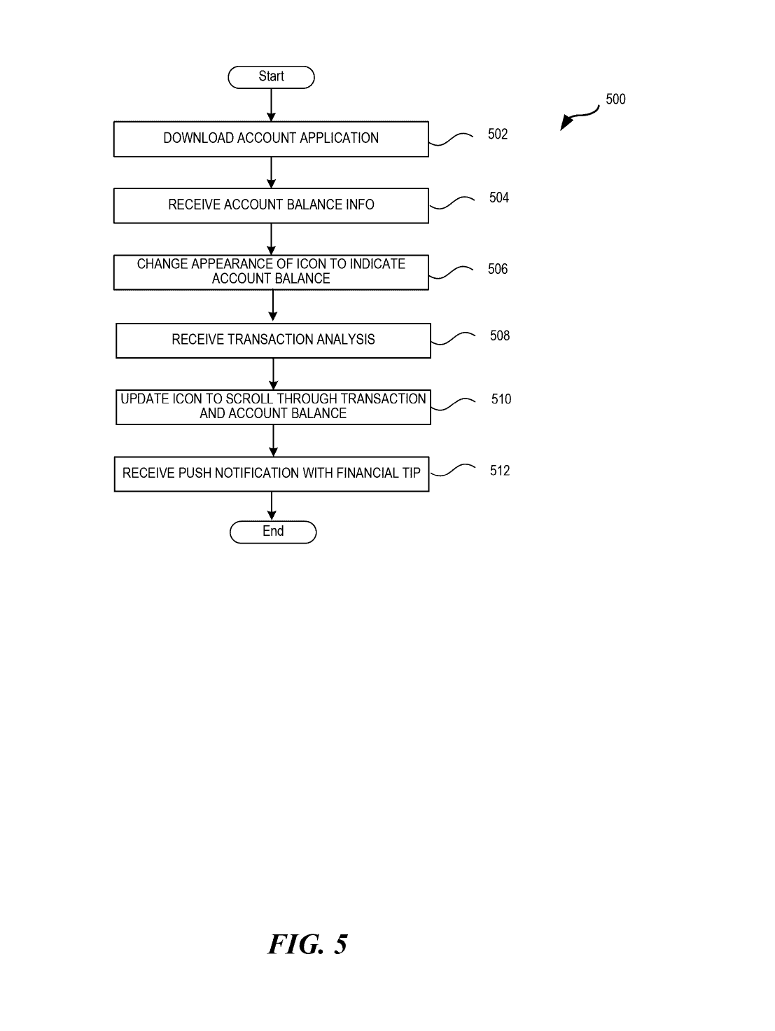

FIG. 5 is a flowchart illustrating a process 500 of providing actionable, dynamic information to the user without requiring the user to have an application open. Downloading operation 502 downloads a prepaid card application onto a device. The application is indicated on the device by an icon. Receiving operation 504 receives account balance information at a device. In response to receiving the account balance, changing operation 506 changes the appearance of the icon according to an account balance (e.g., a yellow icon indicates that funds associated with the prepaid card are low). Receiving operation 508 receives an analysis of a recent transaction (e.g., the cardholder withdrew $20 from an out-of-network ATM). In updating operation 510, the icon may have two different modes that it scrolls through, indicating the account balance as well as the transaction (e.g., “−$20”). If the analysis shows that the transaction was not financially responsible, the device may receive a push notification with a financial tip in receiving operation 512. In some embodiments, the icon could be updated to indicate that a financial tip is available (e.g., via the push notification, text message, inbox of the application email message).

Computer system overview.

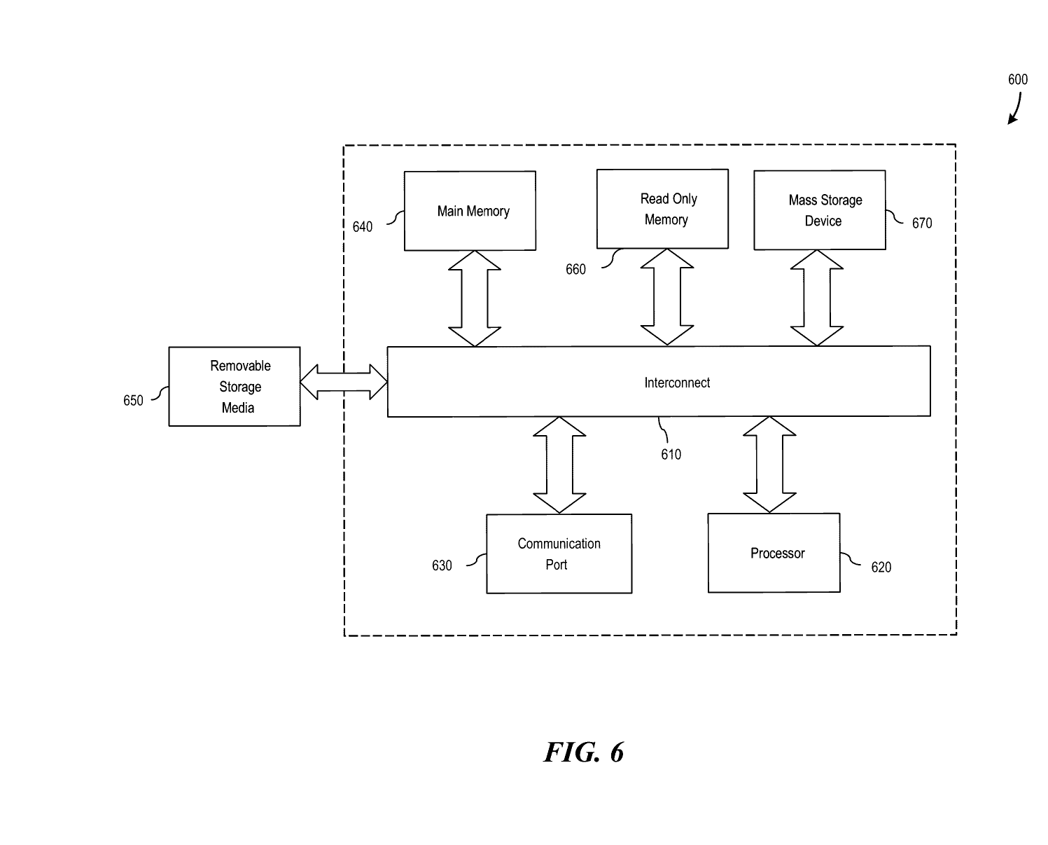

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 6 is an example of a computer system 600 with which embodiments of the present disclosure may be utilized. According to the present example, the computer system 600 includes an interconnect 610, at least one processor 620, at least one communication port 630, a main memory 640, a removable storage media 650, a read only memory 660, and a mass storage device 670.

Processor(s) 620 can be any known processor. Communication port(s) 630 can be or include, for example, any of an RS-232 port for use with a modem-based dialup connection, a 10/100 Ethernet port, or a Gigabit port using copper or fiber. The nature of communication port(s) 630 may be chosen depending on a network such a Local Area Network (LAN), Wide Area Network (WAN), or any network to which the computer system 600 connects.

Main memory 640 can be Random Access Memory (RAM), or any other dynamic storage device(s) commonly known in the art. Read only memory 660 can be any static storage device(s) such as Programmable Read Only Memory (PROM) chips for storing static information such as instructions for processor 620.

Mass storage device 670 can be used to store information and instructions. For example, hard disks such as the Adaptec® family of SCSI drives, an optical disc, an array of disks such as RAID, such as the Adaptec family of RAID drives, or any other mass storage devices may be used.

Interconnect 610 can be or include one or more buses, bridges, controllers, adapters, and/or point-to-point connections. Interconnect 610 communicatively couples processor(s) 620 with the other memory, storage, and communication blocks. Interconnect 610 can be a PCl/PCI-X or SCSI based system bus depending on the storage devices used.

Removable storage media 650 can be any kind of external hard-drives, floppy drives, Compact Disc Read-Only Memory (CD-ROM), Compact Disc-Re-Writable (CD-RW), Digital Video Disc Read-Only Memory (DVD-ROM).

The components described above are meant to exemplify some types of possibilities. In no way should the aforementioned examples limit the disclosure, as they are only exemplary embodiments.

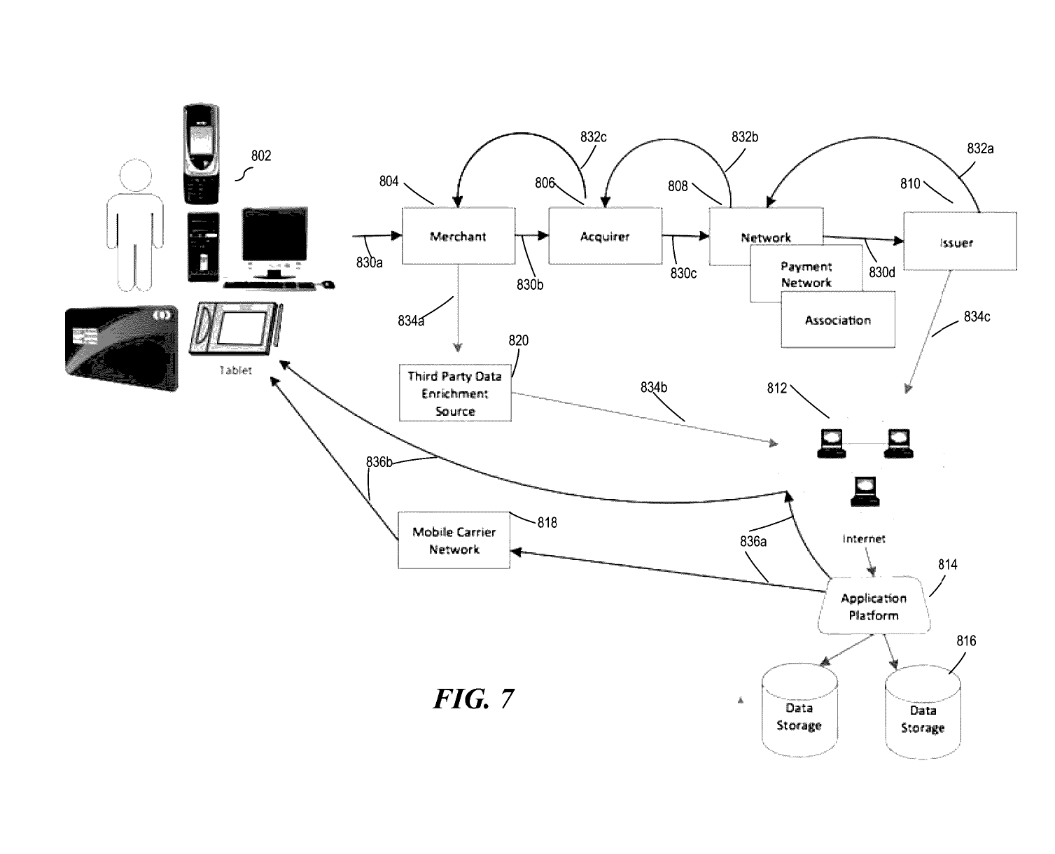

FIG. 7 illustrates an example of a network-based operating environment in accordance with another embodiment of the present disclosure. A user device 802 provides an authorization request 830a to a merchant 804. The authorization request propagates through as 830b to acquirer 806, 830c to Network/Payment Network/Association 808 and 830d to Issuer 810. The authorization response is shown by arrows 832a, 832b and 832c. Inbound enriched data 834c is provided by issuer 810 through Internet 812 to Application Platform 814, which connects to data storage 816. Other enriched data 834a is provided through third party data enrichment source 820 as enriched data 834b, also through Internet 812 to Application Platform 814. Outbound information 836 a is provided to the consumer 802 through Internet 812 or through mobile carrier network 818 as information 836b.

### Terminology.

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

In conclusion, the present disclosure provides novel systems, methods, and arrangements for a financial instrument platform. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

What is claimed is:

1. A non-transitory, computer readable media comprising instructions configured to:
display an icon corresponding to an application on a digital electronic user interface;
display, within the icon, first current content information from the application; and
change the type of information in response to a user input.

2. The non-transitory, computer readable media of claim 1 further comprising instructions configured to:
change the first current content information in response to user interaction with the icon.

3. The non-transitory, computer readable media of claim 2 wherein the user interaction comprises a swipe of the icon.

4. The non-transitory, computer readable media of claim 1 further comprising instructions configured to:
display a badge associated with the icon, the badge providing additional current content information from the application.

5. The non-transitory, computer readable media of claim 1 further comprising instructions configured to:
display a second current information.

6. The non-transitory, computer readable media of claim 1 further comprising instructions configured to:
detect a transaction; and
display a tip associated with the icon and corresponding to the transaction.

7. The non-transitory, computer readable media of claim 6 further comprising instructions configured to:
detect at least two parameters of a location, a merchant, a date, a time of day and an account; and
configure the tip based on the parameters detected.

8. The non-transitory, computer readable media of claim 6 further comprising instructions configured to:
display, with the tip, an indicator of proximity to a location associated with the tip.

9. A non-transitory, computer readable media comprising instructions configured to:
display an icon corresponding to an application on a digital electronic user interface;
display, within the icon, first current content information from the application;
change the type of information in response to a user input.
change the first current content information in response to user interaction with the icon;
display a badge associated with the icon, the badge providing additional current content information from the application; and
display a second current information.

10. The non-transitory, computer readable media of claim 9 further comprising instructions configured to:
detect a transaction;
display a tip image associated with the icon and corresponding to the transaction;
detect at least two parameters of a location, a merchant, a date, a time of day and an account; and
configure the tip image based on the parameters detected.

11. The non-transitory, computer readable media of claim 10 further comprising instructions configured to:
display, with the tip image, an indicator of proximity to a location associated with the tip.

12. The non-transitory, computer readable media of claim 10 further comprising instructions configured to:
display, in response to user interaction with the tip image, further more detailed information.

13. The non-transitory, computer readable media of claim 10 further comprising instructions configured to:
display an icon corresponding to an application on a digital electronic user interface;
display, within the icon, first current content information from the application; and
change the type of information in response to a user input.

14. A non-transitory, computer readable media comprising instructions configured to:
display one of an icon and a badge corresponding to an application on a digital electronic user interface;
display, within the icon, first current content information from the application; and
wherein the first current content information includes a balance available in an account associated with the application.

15. The non-transitory, computer readable media of claim 14 further comprising instructions configured to:
receive updated first current account information wirelessly from a remote server.

16. The non-transitory, computer readable media of claim 15 further comprising instructions configured to:
change the first current content information in response to user interaction with the icon.

17. The non-transitory, computer readable media of claim 16 wherein the user interaction comprises a gesture over the icon.
